(19) United States
(12) Patent Application Publication
(10) Pub. No.: US 2020/0190394 A1
(43) Pub. Date: Jun. 18, 2020

(54) LAYERED DOUBLE HYDROXIDE MATERIALS AS ADDITIVES FOR ENHANCING SCALE SQUEEZE CHEMICAL TREATMENT LIFETIME

(71) Applicant: BP Exploration Operating Company Limited, Middlesex (GB)

(72) Inventors: Saul MOORHOUSE, Godalming (GB); Ian R. COLLINS, Middlesex (GB); Jonathan CROUCH, Addlestone (GB)

(73) Assignee: BP Exploration Operating Company Limited, Middlesex (GB)

(21) Appl. No.: 16/708,766

(22) Filed: Dec. 10, 2019

(30) Foreign Application Priority Data
Dec. 14, 2018 (GB) 1820465.1

(51) Int. Cl. C09K 8/528; E21B 37/06; C09K 8/536

(52) U.S. Cl. CPC C09K 8/528; C09K 8/536; E21B 37/06

(57) ABSTRACT

A scale inhibition fluid for use in a wellbore comprises a layered double hydroxide (LDH) having a scale inhibitor (SI) intercalated between positively-charged layers thereof. Also disclosed is a scale treatment fluid comprising such an LDH and SI and methods of making and using same. The material can be formed prior to use in a wellbore, formed during a treatment, formed within the wellbore, or the LDH can be recharged within a wellbore by injecting a SI after the material has been in place within the wellbore, or any combination thereof.

### CROSS-REFERENCE TO RELATED APPLICATIONS

This application claims priority to United Kingdom Patent Application No. 1820465.1 filed with the Intellectual Property Office of the United Kingdom on Dec. 14, 2018 and entitled “Layered Double Hydroxide Materials as Additives for Enhancing Scale Squeeze Chemical Treatment Lifetime,” the disclosure of which is incorporated herein by reference in its entirety.

### TECHNICAL FIELD

This disclosure relates to scale inhibition in production wells; more specifically, this disclosure relates to scale squeeze treatments; still more particularly, this disclosure relates to scale squeeze treatments utilizing layered double hydroxides (LDHs).

### BACKGROUND

In production systems where there is a downhole scale threat, but no downhole scale inhibitor (SI) injection facilities are in place, alternative barriers to inhibit scale formation in the well may be considered. In a scale squeeze treatment, SI and other chemicals are injected into the reservoir (e.g. pumped in the opposite direction to flow via a production well), left to soak for a period of time, and then produced back to the production facility at surface alongside produced oil, gas, and water, as the well is allowed to flow again. The SI gradually leaches from the rock formation over time, providing inhibition to the well as the scale inhibitor passes through it.

The injection of scale inhibitor into a production well during scale squeeze treatments can be time consuming and therefore costly. Improved scale squeeze treatments are therefore needed to improve efficiency and reduce the requirement for regular re-treatment.

### SUMMARY

Herein disclosed is a scale inhibition fluid for use in a wellbore comprising: a layered double hydroxide (LDH) having a scale inhibitor (SI) intercalated between positively-charged layers thereof.

Also disclosed herein is a scale treatment fluid comprising: a carrier fluid; and a layered double hydroxide (LDH) having a scale inhibitor (SI) intercalated between positively-charged layers thereof.

Further described herein is a scale treatment fluid comprising: a carrier fluid; a layered double hydroxide (LDH) comprising positively-charged layers; and a scale inhibitor (SI), wherein the scale inhibitor comprises one or more ions capable of being intercalated between the positively-charged layers of the LDH.

Also disclosed herein is a method of treating a wellbore, the method comprising: injecting, as part of a scale squeeze treatment of a reservoir, a treatment fluid into the wellbore, wherein the treatment fluid comprises a layered double hydroxide (LDH) comprising positively-charged layers with intercalated anionic layers therebetween; and releasing a scale inhibitor (SI) within the reservoir based on the injection of the treatment fluid comprising the LDH. The anionic layers comprise the SI.

Further disclosed herein is a method of making a wellbore treatment fluid, the method comprising: mixing a layered double hydroxide (LDH) with a solution comprising at least one scale inhibitor (SI), wherein the layered double hydroxide (LDH) solid comprises positively-charged layers with anionic layers comprising one or more anions intercalated between the positively-charged layers; and ion exchanging of the one or more anions with the scale inhibitor to create a material comprising the SI encapsulated in the anionic layers intercalated between the positively-charged layers of the LDH.

Also disclosed herein is a method of treating a wellbore, the method comprising: injecting a scale inhibitor (SI) into a reservoir containing a layered double hydroxide (LDH), wherein the LDH comprises positively-charged layers with intercalated anionic layers therebetween; intercalating the SI into the anionic layers of the LDH within the reservoir; and releasing the SI to provide scale inhibition during production of fluid from the reservoir.

While multiple embodiments are disclosed, still other embodiments will become apparent to those skilled in the art from the following detailed description. As will be apparent, certain embodiments, as disclosed herein, are capable of modifications in various aspects without departing from the spirit and scope of the claims as presented herein. Accordingly, the detailed description hereinbelow is to be regarded as illustrative in nature and not restrictive.

### BRIEF DESCRIPTION OF THE DRAWINGS

The following figures illustrate embodiments of the subject matter disclosed herein. The claimed subject matter may be understood by reference to the following description taken in conjunction with the accompanying figures, in which:

FIG. 1 is a schematic of an intercalation reaction for producing a squeeze lifetime enhancer (SLE), according to embodiments of this disclosure;

FIGS. 2A and 2B are schematics of exemplary reagents and product SLEs, respectively, according to embodiments of this disclosure;

FIG. 3 is a schematic, cross-sectional illustration of an oil recovery system and a reservoir in respect of which embodiments of this disclosure are applicable;

FIG. 4 provides x-ray diffraction (XRD) results obtained in Example 1 for baseline LDH and SLEs comprising diethylenetriamine penta(methylene phosphonic acid (DTPMP)-crab and DTPMP-flat;

FIGS. 5A-5D provide ATR-FTIR spectra of Example 1: FIG. 5A shows the spectra for the hydrotalcite LDH, the DTMP-intercalated LDH, and the phosphonic acid heptasodium salt; FIG. 5B depicts the detailed spectra for the phosphonic acid heptasodium salt; FIG. 5C depicts the detailed spectra for the starting material hydrotalcite LDH; and FIG. 5D depicts the detailed spectra for the SLE product according to an embodiment of this disclosure comprising the DTMP-intercalated LDH;

FIG. 6 is a plot of SI concentration (mg/L) as a function of number of post-flush injected pore volumes for the experiments of Example 2A;

FIG. 7 is a plot of SI concentration (mg/L) as a function of number of post-flush injected pore volumes for the experiments of Example 2B; and

FIGS. 8A and 8B show the results of the formation damage tests of Example 3, with FIG. 8A showing the differential pressure (psi) as a function of time (minutes) for the formation damage test utilizing the control, and FIG. 8B showing the differential pressure (psi) as a function of time (minutes) for the formation damage test utilizing an SLE of this disclosure.

### DETAILED DESCRIPTION

Scale squeeze treatments may be utilized to inhibit scale formation in a well or in a well-bore. A typical scale squeeze program may comprise: (a) a pre-flush treatment comprising chemicals to prepare/prime/clean the rock of the formation for subsequent scale inhibitor injection; (b) a main treatment during which a chemical package primarily comprising the scale inhibitor (SI) is injected; (c) an over-flush during which an over-flush fluid, which is typically the largest by volume of the three chemical packages (of (a), (b), and (c)), and is designed to push the main treatment to an appropriate reservoir depth, is injected; (d) use of a soak, which is typically a 12 to 48 hour period, in which the well is shut-in, allowing chemicals time to adhere to the rock formation; and (e) a flow-back during which the well is brought back online and the chemicals flowed back alongside other produced materials such as oil, gas, and water. Typically one third of the SI chemical is immediately produced back to surface within the first few hours of the flow-back process, with the remaining slowly released from the reservoir over time. Re-treatment typically takes place on a 1- to 2-year cycle, as the concentration of SI being produced from the well decreases and approaches a ‘minimum effective dose’ (MED) The minimum effective dose (MED) is a minimum concentration of SI needed to inhibit scale to a desired degree within the reservoir and/or the well-bore and the well. The scale squeeze treatment lifetime is the time it takes for the concentration of the SI produced back to the well to fall to or below the MED.

Scale squeeze treatments can take several days to complete and, for deepwater wells that require an intervention vessel to complete, can cost more than $10 million to execute. Accordingly, lengthening the squeeze treatment lifetime represents a significant opportunity to reduce costs by reducing the total number of squeeze treatments undertaken over the lifetime of a well.

Herein disclosed are novel layered double hydroxide (LDH) materials and uses thereof. as additives to enhance the lifetime of scale squeeze chemical treatments. Through (pre-treatment, in situ during injection of a treatment fluid, or downhole) intercalation of known scale inhibitor chemistries into LDHs, as per this disclosure, and addition of these novel materials to scale squeeze chemical packages in the field, scale squeeze lifetime extension can be achieved via a plurality of mechanisms. Without limitation, such mechanisms include providing an increased mass of scale inhibitor retained in the reservoir following squeeze treatment and controlled (e.g., slowed) release of the scale inhibitor into the producing well following the squeeze treatment due to encapsulation of the SI via intercalation into the LDH.

Herein disclosed is a layered double hydroxide (LDH) suitable for use as an additive to enhance the lifetime of scale squeeze chemical treatments. In embodiments, the layered double hydroxide (LDH) comprises a scale inhibitor (SI) intercalated between positively-charged layers thereof as described hereinbelow and may be referred to herein as a squeeze lifetime enhancer or ‘SLE’. It is to be understood that although an LDH having a SI intercalated therein is referred to herein as an SLE, an LDH itself can serve as a squeeze lifetime enhancer, in some embodiments according to this disclosure. That is, a SI-charged LDH (referred to herein as an SLE) or a non-SI-charged LDH (referred to herein simply as an LDH) can both be utilized to enhance squeeze lifetime according to embodiments of this disclosure.

In some embodiments, an SLE is formed prior to injection into a wellbore. In some embodiments, an SLE is formed in situ during injection of a fluid comprising both a SI and an LDH as described herein. In some embodiments, an SLE is formed downhole. For example, in embodiments, an SLE is formed by injecting an LDH into a wellbore, and subsequently injecting a SI, whereby the SI is intercalated into the downhole LDH to form an SLE. In embodiments, an SLE is formed by recharging a spent SLE that is already positioned downhole (e.g., an SLE that was previously injected into a wellbore, and from which SI has been lost, for example, due to ion exchange, decomposition/dissolution of the LDH, or other leaching of anions therefrom, as described further hereinbelow) with SI by injecting a SI into the wellbore.

Layered double hydroxides are versatile solid materials. The LDH structure comprises positively-charged layers, with negatively charged anions residing (e.g., in ‘anionic’ or ‘intercalated’ layers) between the positively-charged layers. The anions intercalated between the positively-charged layers are readily interchangeable under the appropriate conditions. Accordingly, LDH structures can be tuned to match an application by ion-exchanging the anions in the negatively-charged layers for a desired intercalated anion. According to this disclosure, one or more anionic scale inhibitor chemicals can be intercalated into an LDH structure and can be utilized (e.g., injected into a reservoir via a well) as an additive in a scale squeeze treatment. In alternative embodiments, an LDH with or without the SI can be injected into a well, and an SI intercalated therein downhole.

Layered double hydroxides (LDH) are a class of ionic solids. LDHs are characterized by a layered structure, having the generic layer sequence [AcBZAcB]ₙ, where c represents layers of metal cations, A and B are layers of hydroxide (OH⁻) anions, and Z are anionic (or, as sometimes referred to herein, ‘intercalated’) layers comprising other anions and/or neutral molecules (e.g., water). Lateral offsets between the layers may result in longer repeating periods. Thus, the anionic or intercalated layers Z can be considered positioned between positively-charged layers, which can comprise AcB.

As noted above, the intercalated anions (e.g., in anionic or intercalated layers Z) may be weakly bound, and exchangeable, making the intercalation properties thereof scientifically and commercially of interest.

LDHs can be seen as derived from hydroxides of mono-, di-, or trivalent cations with the brucite layer structure [AdBAdB]ₙ, for example, via oxidation or cation replacement in the metal ion-containing layers (d), providing an excess positive charge, and corresponding intercalation of anions within layers Z between the hydroxide layers (A, B) to neutralize the excess positive charge, resulting in the structure [AcBZAcB]ₙ. LDHs can be formed with a wide variety of anions in the intercalated layers Z, such as, without limitation, Cl⁻, C₃²⁻, Br⁻, NO₃, and SO₄²⁻. It is noted that the LDH structure is unusual, since many materials with similar structure (including clay minerals, such as montmorillonite) comprise negatively charged main metal layers c and positive ions in the intercalated layers Z. Accordingly, the LDH structure is particularly useful as an additive for scale squeeze lifetime enhancement due to the positive charge of the surface area (e.g., the positively-charged layers), which promotes retention of the SLE of this disclosure within a rock formation due to adsorption of the SLE onto the rock formation.

In embodiments, the positive layer consists of divalent and trivalent cations, and the LDH can be represented by Formula (1):

[M²⁺₁₋ₓN³⁺ₓ(OH⁻)_{2]}^{α+}(Xⁿ⁻)_{α/n} .yH₂O, (1)

wherein Xnⁿ⁻represents the intercalating anion (or anions). In embodiments, [M²⁺₁₋ₓN³⁺ₓ(OH⁻)₂]^{α+} of Formula (1) represents the positively-charged layer (e.g.,‘AcB’) of an LDH as described herein, and (Xⁿ⁻)_{α/n}.yH₂O represents the anionic or intercalating layer (e.g., ‘Z’).

In embodiments, M²⁺ is Ca²⁺, Mg²⁺, Mn²⁺, Fe²⁺, Co²⁺, Ni²⁺, Cu^{2 +} or Zn²⁺, and N³⁺ is a trivalent cation, such as, without limitation Al³⁺, Cr³⁺, Mn³⁺, Fe³⁺, Co³⁺, Ni³⁺, or Ga^{'+} possibly of the same element as M. In some embodiments, 0.2≤×≤0.33. In some embodiments, x is variable. In some embodiments, x is 0.1≤×≤0.5. In some embodiments, x is greater than about 0.5.

In some embodiments, the LDH is from another class of LDH for which the main metal layer c comprises or consists of Li⁺ and Al³⁺ cations, with the general Formula (2):

[LiAl₂(OH)₆]X.yH₂O, (2)

where X represents one or more anions, e.g., CO₃²⁻. The value of y can be between about 0.5 and 15.

In some embodiments, the LDH contains mixtures of greater than one type of M²⁻ or M³⁺ ion within the layers, which can be called ternary LDHs. In these ternary LDHs, M³⁺ can be substituted for M⁴⁺, where M⁴⁺ is a tetravalent cation, such as, without limitation Ti⁴⁻, Zr⁴⁺, and Sn⁴⁺.

In some embodiments, the LDH modified as per this disclosure to form an SLE is a naturally occurring LDH. Such mineralogical LDHs can be classified as members of the hydrotalcite supergroup, named after the Mg-Al carbonate hydrotalcite. In embodiments, the divalent cations M²⁺ include one or more of Mg, Ca, Mn, Fe, Ni, Cu and Zn. In embodiments, the trivalent cations N³⁺ include one or more of Al, Mn, Fe, Co and Ni. In embodiments, prior to incorporation of the SI into the intercalation layers as per this disclosure (e.g., prior to injection into the reservoir and/or in situ downhole) the LDH comprises one or more intercalated anions selected from CO₃²⁻, SO₄²⁻, Cl⁻, OH⁻, S₂⁻ and [Sb(OH)₆]⁻. In embodiments, the LDH comprises a hydrotalcite from one of the following subgroups: (1) the hydrotalcite group, with M²⁺: N^{3+:=}3:1 (layer spacing of about 7.8 Å); (2) the quintinite group, with M⁺² : N⁺³ 2:1 (layer spacing of about 7.8 Å); the fougèrite group of natural ‘green rust’ phases, with M⁺²=Fe⁺², N⁺³=Fe^{30 3} in a range of ratios, and with O⁻² replacing OH⁻¹ in the brucite module to maintain charge balance (layer spacing of about 7.8 Å); (4) the woodwardite group, with variable M⁺²:M⁺³ and interlayer [SO_{4]}⁻², leading to an expanded layer spacing of about 8.9 Å; (5) the cualstibite group, with interlayer [Sb(OH)₆]⁻ and a layer spacing of about 9.7 Å; (6) the glaucocerinite group, with interlayer [SO₄]⁻² as in the woodwardite group, and with additional interlayer H₂O molecules that further expand the layer spacing to about 11 Å; (7) the wermlandite group, with a layer spacing of about 11 Å, in which cationic complexes occur with anions between the brucite-like layers; and/or (8) the hydrocalumite group, with M⁺²=Ca⁺² and N⁺³=Al, which contains brucite-like layers in which the Ca:Al ratio is 2:1 and the large cation, Ca⁺², is coordinated to a seventh ligand of ‘interlayer’ water.

In some embodiments, the LDH comprises hydrotalcite, hydrocalumite, or a combination thereof. In some embodiments, an SLE of this disclosure comprises a (e.g., naturally-occurring) layered double hydroxide (LDH) that has been ion exchanged with an anionic SI. The scale inhibitor can comprise any suitable anionic scale inhibitor. The scale inhibitor is effective in stopping calcium and/or barium scale with threshold amounts rather than stoichiometric amounts. In embodiments, the SI may be a water-soluble organic molecule comprising at least two phosphonic acid and/or sulphonic acid groups (e.g., 2-30 such groups). In embodiments, the SI may be a water-soluble organic molecule comprising at least two carboxylic groups (e.g., 2-30 such groups). In embodiments, the scale inhibitor is an oligomer or a polymer, or may be a monomer with at least one hydroxyl group and/or amino nitrogen atom, especially in a hydroxycarboxylic acid or hydroxy or aminophosphonic, or, sulphonic acid. The inhibitor can be primarily effective for inhibiting calcium and/or barium scale. Examples of such compounds used as inhibitors include, without limitation, aliphatic phosphonic acids comprising from 2 to 50 carbons, such as hydroxyethyl diphosphonic acid, and aminoalkyl phosphonic acids, e.g. polyaminomethylene phosphonates with 2-10N atoms, e.g. each bearing at least one methylene phosphonic acid group; examples of the latter are ethylenediamine tetra(methylene phosphonate), diethylenetriamine penta(methylene phosphonate) and the triamine- and tetramine-polymethylene phosphonates with 2-4 methylene groups between each N atom, at least 2 of the numbers of methylene groups in each phosphonate being different. Such compounds are described further in published EP-A-479462, the disclosure of which is hereby incorporated herein by reference in its entirety for purposes not contrary to this disclosure. Other scale inhibitors include, without limitation, polycarboxylic acids, such as lactic or tartaric acids, and polymeric anionic compounds, such as polyvinyl sulphonic acid and poly(meth)acrylic acids, optionally with at least some phosphonyl or phosphinyl groups as in phosphinyl polyacrylates. The scale inhibitors are suitably at least partly in the form of the alkali metal salts thereof, e.g. sodium salts thereof. In some embodiments, the SI comprises diethyleneamine penta(methylene) phosphonic acid (DTPMP). In some embodiments, DTPMP is intercalated into the layered double hydroxide to form an SLE according to this disclosure. DTPMP is also known as DETA phosphonate, DTPMP phosphonate, diethylenetriamine penta(methylene phosphonic acid), and DTPMPA.

In some embodiments, multiple scale inhibitors can be incorporated into an LDH, to provide an SLE of this disclosure. Thus, in some embodiments, an SLE of this disclosure comprises at least a second scale inhibitor (SI) intercalated between positively-charged layers of the LDH.

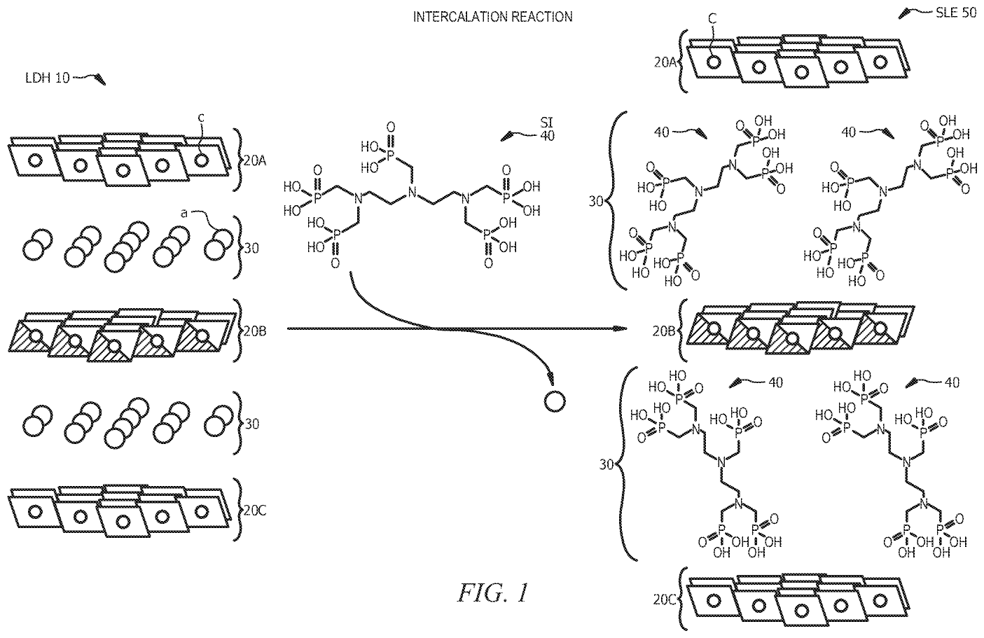

FIG. 1 is a schematic of an intercalation reaction for producing a squeeze lifetime enhancer (SLE) 50, according to embodiments of this disclosure. According to embodiments of this disclosure, an LDH 10 comprising positively-charged layers 20A, 20B, 20C comprising cation(s) ‘c’, and anionic (or ‘intercalated’) layers 30 comprising anions ‘a’ is ion exchanged with one or more SI 40, whereby the anions ‘a’ are replaced by the anionic SI 40, thus producing an SLE 50. SLE 50 comprises positively-charged layers 20A, 20B, 20C comprising cations ‘c’ and anionic or intercalating layers 30 comprising SI 40. Accordingly, the SLE 50 can have the formula [AcBZAcB]ₙ, wherein the intercalating or anionic layer 30 (e.g., ‘Z’) comprises the anionic SI, and the positively-charged layers 20A/20B/20C (e.g., ‘AcB’) comprise hydroxide layers A and B and cation-containing metal layers c. As discussed further below positively-charged layers 20 (e.g., 20A, 20B, and 20C) can be the same or different, in embodiments.

The SLEs can be tuned to a particular application (e.g., a particular rock formation of a reservoir). For example, as detailed further hereinbelow, the SLE can be optimized regarding: positively-charged layer structure and stacking. For example, alternating (e.g., ABAB) stacking vs. repeating (e.g., AAA) stacking of positively-charged layers can impact on intercalation properties). The SLE can be optimized regarding composition, order, density, and/or ratio of cations within the layers. In this manner, the composition of the positively charged layers can be tuned to improve performance as a squeeze lifetime enhancer or SLE. For example, the charge density in the positively charged layers can be tuned to create a stronger affinity to the anion (e.g., the SI) in the intercalation layers to provide a desired (e.g., a slower) release of the SI. In embodiments, the SLE can be optimized regarding cation order. Different cations may be utilized to provide a different degree of order in the positively charged layers, and this order can be adjusted or selected to tune the interaction of the LDH with a formation and/or a SI. The SLE can be optimized regarding the anion (e.g., SI) loading between the layers. For example, synthesis methods can be utilized to maximize the weight percent (wt %) loading of anions per mass of LDH. The SLE can be optimized regarding particle size. For example, the LDH or SLE particle size can be adjusted depending on the porosity of the rock formation being treated. The SLE can be optimized regarding particle morphology. For example, depending on the composition of the rock formation being treated via scale squeeze, a certain morphology (e.g., rods, platelets, cuboids, spheres, flowers, etc.) may have preferential adherence to the rock formation.

In embodiments, the composition (e.g., which cations reside in the positively-charged layers), the density (e.g., the ratio of cations in the cationic layers to anions in the SI), the order, the structure, and/or the stacking of the positively-charged layers 20 (e.g., 20A, 20B, 20C) of the LDH 10 provides desired intercalation properties. For example, in embodiments, cationic layers 20A, 20B, and 20C are the same. Alternatively, one or more of the positively-charged layers are different from at least one other of the positively-charged layers. For example, in embodiments, positively-charged layers 20A and 20C are the same, and positively-charged layer 20B is different (e.g., comprises a different cation or a different density of cations).

In embodiments, an SLE of this disclosure comprises a weight percent (wt %) loading of anions from the SI(s) intercalated therein per mass of the LDH that is greater than or equal to about 50%, 60%, 70%, 80%, 90%, or 100% of a maximum weight percent (wt %) loading of the anions. In embodiments, the SLE may be designed to optimize anion (e.g., SI) loading between the positively-charged layers, for example, to maximize the weight percent loading of anions per mass of the LDH.

In embodiments, the LDH, the SLE, or both comprise particles which have at least one dimension and/or an equivalent spherical diameter that is submicron in size. As utilized herein, submicron indicates a dimension, as measured by scanning electron microscopy or an equivalent spherical diameter, as measured by dynamic light scattering, of less than 1 micron. In embodiments, the LDH, the SLE, or both comprise particles which have at least one dimension and/or an equivalent spherical diameter that is nanoparticulate. As utilized herein, nanoparticulate indicates at least one dimension of the particulate having a size of less than 100 nm, for example 1 to 100 nm (10 to 1000 Angstroms (Å)), as measured by scanning electron microscopy or an equivalent spherical diameter, as measured by dynamic light scattering, of less than 100 nm, for example from 1 to 100 nm (10 to 1000 Angstroms (Å)). In embodiments, the LDH, the SLE, or both have a particle size distribution including particles having a particle size in a range of from about 1 to about 1000 nm, from about 10 to about 100nm, from about 100 to about 500 nm, or from about 500 nm to about 1000 nm. In embodiments, the LDH, the SLE, or both have an average particle size in a range of from about 1 to about 1000 nm, from about 10 to about 100 nm, from about 100 to about 500 nm, or from about 500 nm to about 1000 nm.

Desirably, in embodiments, the LDH, the SLE, or both have a particle size that can be injected via a wellbore into a rock formation of a reservoir, and not cause formation damage. In embodiments, the LDH, the SLE, or both comprise particles having an equivalent spherical particle size, as measured by Dynamic Light Scattering (DLS), that is less than about 1/7, 1/10, or 1/14^{th} of a mean pore throat diameter of the rock formation. In embodiments, the LDH, the SLE, or both comprise particles having all dimensions that are less than about 1/7, 1/10, or 1/14^{th} of a mean pore throat diameter of the rock formation.

For utilization as a squeeze fluid, it may be desirable for a greater surface area (SA) of the LDH to be exposed. In embodiments, the LDH, the SLE, or both comprise particles having a surface area, as measured by nitrogen adsorption (Brunauer-Emmett-Teller (BET) method), that is greater than about 10, 15, 20, 25, 30, 35, or 40 m²/g. Enhanced surface area may be provided, in embodiments, by utilizing an SLE having a morphology selected from platelets, rods, cuboids, spheres, flowers, or a combination thereof. In embodiments, an LDH with a desired (e.g., positive) surface charge density is utilized to maximize adherence onto a particular reservoir geochemistry. In this manner, the physical properties of the SLE can be tuned to a particular application, in embodiments.

Also disclosed herein is a scale treatment fluid and/or as a scale inhibition fluid (collectively referred to as a scale treatment fluid) comprising at least one LDH or SLE of this disclosure. As used herein, the term “fluid” refers to anything that flows in response to pressure, including liquids and suspensions. The scale treatment fluid can be utilized in a pre-flush, a main chemical treatment, or an over-flush. The fluid can comprise the LDH or the SLE as a solid within a carrier liquid (e.g., a suspension, etc.). In embodiments, for example, the scale treatment fluid of this disclosure comprises SI and less than or equal to about 10, 9, 8, 7, 6, 5, 4, 3, 2, or 1 weight percent (wt %) of an SLE as described herein. In embodiments, a scale treatment fluid of this disclosure comprises an LDH and/or an LDH with an SI as disclosed herein, and an SLE of this disclosure is formed in situ. For example, in embodiments, a pre-flush fluid and/or main chemical treatment can comprise an LDH, an over-flush fluid containing SI can be introduced into the reservoir being subjected to the scale squeeze treatment (e.g., via a production well), and an SLE of this disclosure can be formed in situ in the reservoir (e.g., when the injected SI is in contact with, soaked in, and/or produced back past the LDH that was deposited in and adsorbed on the surface of the reservoir). Similarly, in embodiments, following a traditional pre-flush and main chemical treatment, an over-flush fluid comprising an LDH of this disclosure can be introduced into the reservoir being subjected to the scale squeeze treatment (e.g., via a production well), and an SLE of this disclosure is formed in situ in the reservoir (e.g., when previously injected SI is produced back past the LDH that was deposited in (and adsorbed on the surface of) the reservoir with the over-flush fluid). Alternatively or additionally, an SLE of this disclosure can be formed in situ in a carrier fluid (e.g., a pre-flush fluid, main chemical treatment fluid, or over-flush fluid) comprising an LDH and SI during introduction into the reservoir. Further alternatively or additionally, an SLE of this disclosure can be produced and subsequently combined with a traditional scale treatment fluid (e.g., a pre-flush fluid, a main chemical treatment fluid, or an over-flush fluid) for introduction into the wellbore. Furthermore, in embodiments, recharging of an SLE downhole can be effected by injecting SI downhole into a formation into which an SLE has previously been injected (or formed in situ), and subsequently leached of SI. In this manner, a subsequent squeeze treatment can, in embodiments, entail injection of a SI without injection of additional LDH, whereby a ‘spent’ SLE can be recharged in situ.

A quantity (e.g., mass) of LDH or SLE in the treatment or treatment fluid can be tuned to balance a pay-off between maximizing the mass of LDH or SLE additive in the treatment (and therefore the squeeze lifetime) and avoiding formation damage through injection of excess solid into the formation. Sub-micron sized particles of the LDH or SLE (e.g., ‘nanotechnology’) can be utilized as a means to achieve facile injection into the reservoir. Generally, injecting particles having a size of less than about 1/14 that of the mean pore throat diameter of pores in a rock formation prevents formation damage due to the solid injection.

Also disclosed herein is a method of making a wellbore treatment fluid, the method comprising mixing a layered double hydroxide (LDH) solid comprising positively-charged layers with anionic layers comprising one or more anions intercalated between the positively-charged layers with a solution comprising at least one scale inhibitor (SI), whereby ion exchange of the one or more anions with the scale inhibitor provides a material comprising the SI encapsulated in the anionic layers between the positively-charged layers of the LDH. The method can further comprise mixing for a time period of at least 1, 2, 3, 4, 5, or 6 hours, filtering to separate solid from liquid subsequent to the mixing, washing the separated solid after filtering, or a combination thereof.

Alternatively or additionally, as noted hereinabove, an SLE can be formed in situ by introducing an LDH into a wellbore separately from or in admixture with an SI. For example, injection of an LDH not having an SI intercalated therein into a wellbore subsequent introduction of a SI into the wellbore via a pre-flush or main chemical treatment may result in the production of an SLE of this disclosure down hole, as the fluids are produced back to the well, the SI flows past the LDH, and ion exchange of the anions in the LDH with the SI results in intercalation of the SI into the intercalation layers of the LDH. In embodiments, an SI and an LDH not comprising intercalated SI are introduced into a wellbore together, and an SLE of this disclosure forms in situ during introduction of the treatment fluid comprising both the LDH and the SI into the wellbore. In embodiments, an SLE is formed in situ during recharging of a downhole SI-depleted SLE (e.g., an SLE from which SI has leached over time).

The SI and the LDH utilized in the method of making the SLE can be as described hereinabove. For example, by way of a non-limiting example, in embodiments, the SI comprises diethyleneamine penta(methylene) phosphonic acid (DTPMP), and the LDH into which the SI is intercalated via ion exchange comprises hydrotalcite.

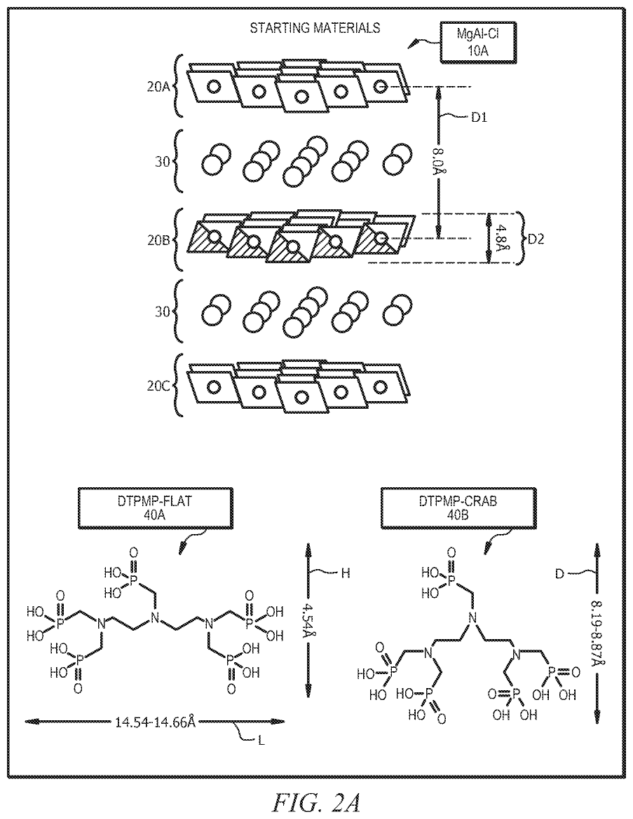

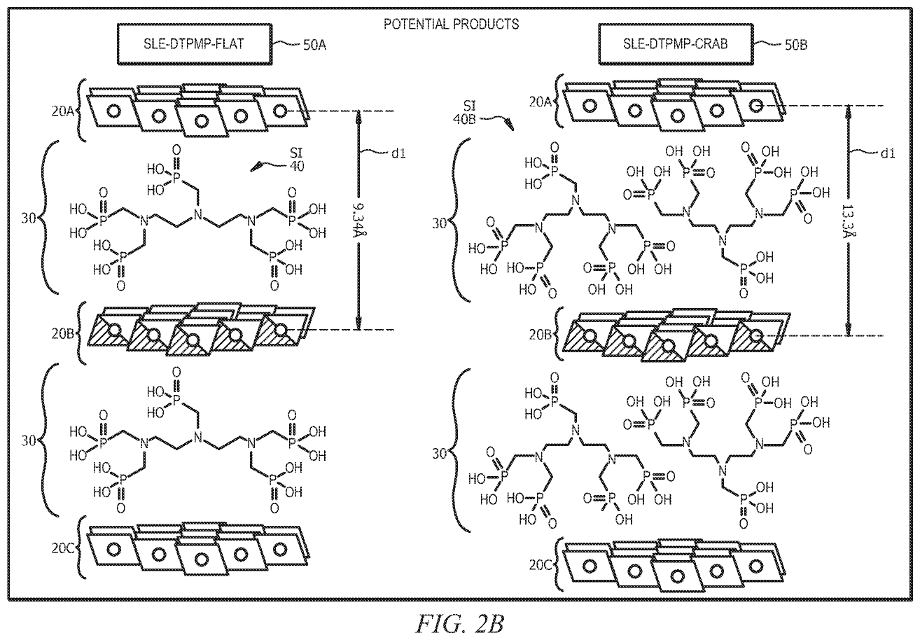

As indicated in FIG. 2A, which is a schematic of exemplary reagents utilized to produce an SLE according to an embodiment of this disclosure, an LDH 10A can comprise a magnesium aluminum chloride (MgAl-Cl) hydrotalcite. Such an LDH can have the composition of Formula (1), wherein M⁺² of positively-charged layers 20A, 20B, 20C is magnesium (Mg⁺²), N^{30 3} of positively-charged layers 20A, 20B, 20C is aluminum (A1⁺³), and the anions X of the intercalating layer 30 comprise chloride ions (CO.

In embodiments, the MgAl-Cl hydrotalcite has a center-to-center or ‘inter-layer’ distance di between positively-charged layers 20 (or between metal cation layers c) of about 8.0 Å, a positively-charged layer thickness d₂ of about 4.8 Å, or both. The SI can be, for example as depicted in the embodiment of FIG. 2A, DTPMP-flat 40A, which has a height H of about 4.5 Åand a length L in a range of from about 14.5 to about 14.7 Å. Alternatively or additionally, the SI can comprise DTPMP-crab, which has a diameter of about 8 to about 9 Å. The schematic of FIG. 2A is exemplary, and various LDHs and SIs can be utilized, as per this disclosure, to produce an SLE for use in squeeze treatment. The size and composition of the positively-charged layers 20 and the anionic or intercalating layers 30 can be selected/adjusted to provide desired properties in the resultant SLE 50.

As depicted in the embodiment of FIG. 2B, which is a schematic of exemplary product SLEs, according to embodiments of this disclosure, the resultant SLE can comprise SLE 50A comprising intercalate DTPMP-flat 40A or SLE 50B comprising intercalate DTPMP-crab 40B in intercalation layers 30. SLE 50A can have an inter-layer distance di between positively-charged layers 20 of about 9.34 Å, while SLE 50B can have an inter-layer distance di between positively-charged layers 20 of about 13.3 Å.

In embodiments, an SLE of this disclosure can be synthesized by stirring a known mass of chloride intercalated hydrotalcite solid in a solution containing an excess of DTPMP for 3-6 hours. The stirred solution can then be filtered and washed, in some embodiments.

Also disclosed herein is a method of treating a wellbore by injecting into the wellbore, as part of a scale squeeze treatment of a reservoir, a layered double hydroxide (LDH) comprising positively-charged layers with intercalated anionic layers therebetween.

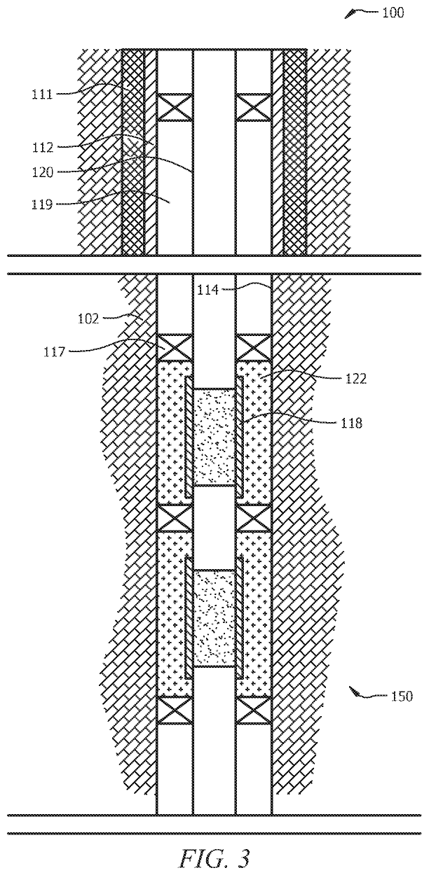

In order to describe the scale squeeze treatment process, a wellbore environment is described with respect to FIG. 3 which is a schematic, cross-sectional illustration of an oil recovery system and a reservoir in respect of which embodiments of this disclosure are applicable. In order to provide an overview of an injection well system, FIG. 3 illustrates an example of a wellbore operating environment 100. A scale squeeze treatment process as described herein may be utilized to inhibit scale anywhere in the production system, including, without limitation, within a production well, a wellbore, downstream processing facilities, or a combination thereof.

A wellbore 114 may be drilled into a subterranean formation 102 using any suitable drilling technique. The wellbore 114 can extend substantially vertically away from the earth's surface over a vertical wellbore portion, deviate from vertical relative to the earth's surface over a deviated wellbore portion, and/or transition to a horizontal wellbore portion. In alternative operating environments, all or portions of a wellbore may be vertical, deviated at any suitable angle, horizontal, and/or curved. The wellbore may be a new wellbore, an existing wellbore, a straight wellbore, an extended reach wellbore, a sidetracked wellbore, a multi-lateral wellbore, and other types of wellbores for drilling and completing one or more production zones. Further, the wellbore may representative of both producing wells and injection wells. The wellbore may also be used for purposes other than hydrocarbon production such as geothermal recovery and the like. As illustrated, the substantially vertical producing section 150 of the wellbore 114 can be an open hole completion. While shown as an open hole, the horizontal section of the wellbore, the invention will work in any orientation, and in open or cased hole.

A wellbore tubular 120 may be lowered into the subterranean formation 102 for a variety of drilling, completion, workover, treatment, production, and/or injection processes throughout the life of the wellbore. The embodiment shown in FIG. 3 illustrates the wellbore tubular 120 in the form of a completion assembly string that can be used for fluid (e.g., scale treatment fluid) injection. It should be understood that the wellbore tubular 120 is equally applicable to any type of wellbore tubulars being inserted into a wellbore including as non-limiting examples drill pipe, casing, liners, jointed tubing, and/or coiled tubing. Further, the wellbore tubular 120 may operate in any of the wellbore orientations (e.g., vertical, deviated, horizontal, and/or curved) and/or types described herein. In an embodiment, the wellbore may comprise wellbore casing 112, which may be cemented into place with cement 111 in at least a portion of the wellbore 114.

In some embodiments, the operating environment can comprise a workover and/or drilling rig positioned on the earth's surface and extending over and around a wellbore 114 that penetrates a subterranean formation 102 for the purpose of recovering hydrocarbons. In some embodiments, a platform or other offshore platform can be used as a producing and/or injection surface for the hydrocarbons.

The wellbore tubular 120 can be positioned within the wellbore 114 and extending from the surface to the producing zones. The wellbore tubular 120 generally provides a conduit for fluids to travel from the surface to the formation 102 for injection or from formation 102 upstream to the surface for production. In some embodiments an injection assembly comprising the wellbore tubular 120 can comprise various equipment or downhole tools to allow fluids to be injected into one or more zones within the subterranean formation. The one or more downhole tools may take various forms. For example, a zonal isolation device 117 may be used to isolate the various zones within a wellbore 114 and may include, but is not limited to, a packer (e.g., production packer, gravel pack packer, frac-pac packer, etc.). One or more injection subassemblies can be used to control the flow of injection fluid into the subterranean formation 102 from the wellbore 114.

Fluid can be injected into the subterranean formation to improve the recovery of oil from the subterranean formation 102 in another production well. In general, a scale treatment fluid of this disclosure can be injected into one or more layers of reservoir rock of subterranean formation 102 from an injection well to provide scale inhibition when fluid flows back through the reservoir towards a production well from which the oil is recovered. As described in more detail hereinbelow, the scale treatment fluid can comprise an LDH or SLE of this disclosure to improve scale squeeze lifetime.

As noted hereinabove, the LDH can be injected into the wellbore 114 of an injection well as a component of a pre-flush fluid, a main scale treatment fluid comprising a scale inhibitor (SI), an over-flush fluid employed to push the main treatment fluid to a desired depth of the reservoir, or a combination thereof. As noted above, in embodiments, the layered double hydroxide (LDH) is an SLE of this disclosure containing the scale inhibitor (SI) intercalated in the intercalated anionic layers between the positively-charged layers. In alternative or additional embodiments, the LDH injected into the reservoir does not contain the SI intercalate, but the SI is intercalated into the LDH to produce an SLE of this disclosure in situ, either during injection (e.g., when combined with an SI to produce a treatment fluid) or following injection (e.g., downhole) of the LDH into the reservoir. For example, as noted previously, when an LDH is injected into a reservoir as a component of an over-flush fluid, once flow back of production fluids (and SI injected during main chemical treatment) occurs past the LDH adhered to the formation, an SLE of this disclosure may be formed in situ in the reservoir via ion exchange of the anions of the LDH with the anionic SI.

The SLE injected into the wellbore or formed in situ can further comprise at least one additional scale inhibitor (SI) intercalated in the intercalated anionic layers between the positively-charged layers. The SI can be any SI noted hereinabove, for example, diethyleneamine penta(methylene) phosphonic acid (DTPMP), and the LDH can comprise any suitable LDH, such as, without limitation, hydrotalcite.

The SLE can comprise a weight percent (wt %) loading of anions from the SI per mass of the LDH that is greater than or equal to about 50%, 60%, 70%, 80%, 90%, or 100% of a maximum wt % loading of the anions. In embodiments, the anion loading provides an SLE having neutral charge. In embodiments, the LDH, the SLE, or both comprise particles which have at least one dimension and/or an equivalent spherical diameter that is submicron in size. As utilized herein, submicron indicates a dimension, as measured by scanning electron microscopy or an equivalent spherical diameter, as measured by dynamic light scattering, of less than 1 micron. In embodiments, the LDH, the SLE, or both comprise particles which have at least one dimension and/or an equivalent spherical diameter that is nanoparticulate. As utilized herein, nanoparticulate indicates a size of less than 100 nm, for example 1 to 100 nm (10 to 1000 Angstroms (Å)), as measured by scanning electron microscopy or an equivalent spherical diameter, as measured by dynamic light scattering, of less than 100 nm, for example from 1 to 100 nm (10 to 1000 Angstroms (Å)). In embodiments, the LDH, the SLE, or both have a particle size distribution including particles having a particle size in a range of from about 1 to about 1000 nm, from about 10 to about 100 nm, from about 100 to about 500 nm, or from about 500 nm to about 1000 nm. In embodiments, the LDH, the SLE, or both have an average particle size in a range of from about 1 to about 1000 nm, from about 10 to about 100 nm, from about 100 to about 500 nm, or from about 500 nm to about 1000 nm.

Desirably, in embodiments, the LDH, the SLE, or both have a particle size that can be injected via a wellbore into a rock formation of a reservoir, and not cause formation damage. In embodiments, the LDH, the SLE, or both comprise particles having an equivalent spherical particle size, as measured by Dynamic Light Scattering (DLS), that is less than about 1/7, 1/10, or 1/14^{th} of a mean pore throat diameter of the rock formation. In embodiments, the LDH, the SLE, or both comprise particles having all dimensions that are less than about 1/7, 1/10, or 1/14^{th} of a mean pore throat diameter of the rock formation.

In embodiments, the LDH comprises particles having a surface area, as measured by nitrogen adsorption (Brunauer-Emmett-Teller (BET) method), that is greater than about 10, 15, 20, 25, 30, 35, or 40 m²/g. To enhance the surface area, in embodiments, the particles of the SLH, the SLE, or both, can have a morphology selected from platelets, cuboids, spheres, flowers, rods, or a combination thereof.

In embodiments, the method further comprises selecting an LDH having a composition (e.g., specific cation(s)), a cation density or ratio of cations to anions of the SI, structure (e.g., inter-layer distance di or thickness d₂), and/or stacking of the positively-charged layers thereof that provides desired intercalation properties between the LDH and the scale inhibitor (SI) (e.g., strength of binding between the anions of the SI and the positively-charged layers).

In embodiments of the method, the LDH or SLE is injected into the wellbore as a component of a treatment fluid comprising less than or equal to about 10, 9, 8, 7, 6, 5, 4, 3, 2, or 1 weight percent (wt %) of the LDH or the SLE, respectively. In embodiments, the treatment fluid further comprises a traditional pre-flush, main chemical treatment, or over-flush fluid. For example, in embodiments, the treatment fluid further comprises from about 10 to about 25, from about 10 to about 20, from about 5 to about 25, or less than or equal to about 20, 15, or 10 wt % of an SI (which may comprise an SI intercalated in an LDH, an SI injected with an LDH for in situ intercalation therein, a separate SI injected in addition to that contained within an SLE, an SI injected (e.g., without an LDH or SLE) to recharge an LDH or depleted SLE downhole, or a combination thereof).

Utilization of the LDH to encapsulate one or more SI and produce an SLE in a wellbore treatment method as per embodiments of this disclosure can result in the following squeeze enhancement mechanisms, whereby the scale squeeze lifetime is increased relative to a same wellbore treatment that is absent of LDH: (a) increasing a mass of the SI retained in the reservoir following the scale squeeze treatment; and/or (b) slowing the release of the one or more SI from the reservoir. As utilized herein, the scale squeeze lifetime is the time for the concentration of the SI produced back to the production facility to fall below a minimum effective dose (MED) In embodiments, utilization of the method of treating a wellbore according to embodiments of this disclosure increases the mass of the SI retained in the reservoir, the scale squeeze lifetime, or both by at least about 10, 15, 20, 25, 30, 35, 40, 45, 50, 55, 60, 65, 70, 75, 80, 85, 90, 95, or 100%.

The mass of scale inhibitor retained in the reservoir following the scale squeeze treatment (a) can be enhanced via the disclosed method due to encapsulation of the SI within the LDH structure, and increased surface area in the reservoir formation through the addition of the solid LDH/SLE particles which reside in the pore spaces, and the corresponding adherence of the SI to the positively charged surfaces of the LDH/SLE.

The slower release of scale inhibitor into the producing well following scale squeeze treatment (b) can be effected via the herein-disclosed method due to encapsulation of an SI into an LDH to produce an SLE, and the slow release or deintercalation of the scale inhibitor from within the LDH structure of the SLE. Without wishing to be limited by theory, the slow release can be due to the gradual ion exchange as reservoir brine flows through the pore spaces and inorganic species (e.g., chloride ions) from the brine replace the SI in the negatively-charged layers of the SLE, decomposition or dissolution of the LDH, or both. As utilized here, decomposition or dissolution of the LDH is intended to indicate release of the SI due to a structural change of the LDH (e.g., loss of cations therefrom).

In embodiments, the herein-disclosed wellbore treatment method can further comprise recharging the LDH or SLE introduced into the reservoir as part of the scale squeeze treatment with SI by introducing additional SI into the reservoir after the scale squeeze treatment, whereby at least a portion of the additional SI is encapsulated by the LDH already present in the reservoir. Re-charging of the LDH material as it remains in the reservoir can, in embodiments, enable re-treatment without the addition of further LDH/SLE additive if LDH is already in the formation from a previous treatment in which the LDH was introduced (e.g., as non-SI exchanged LDH or as ion exchanged LDH (e.g., as SLE).

As well as the material properties discussed hereinabove, there are a number of ways in which LDH/SLE application can be further adapted and optimized depending on a required treatment. For example, the LDH/SLE can be utilized in pre-flush or over-flush stages, instead of as part of the main chemical treatment of a scale squeeze treatment. In embodiments in which the SLE is sensitive to pH, utilization in over-flush may prevent disassociation of the intercalated SI from an SLE of this disclosure, for example, because the over-flush fluid may have a larger volume and/or more neutral pH than a treatment fluid utilized during a pre-flush and/or a main chemical treatment. In embodiments, different scale inhibitor intercalates can be utilized within the SLE structure, as well as, optionally, non-scale inhibitor ions for cases when ‘in situ charging’ may be desired.

The herein-disclosed method of treating a wellbore can provide positive side effects, in embodiments, for example, in embodiments, as scale inhibitor is leached from the SLE, it may act as a sponge for hydrogen sulfide (H₂S) in sour reservoirs, thus mitigating the threat of reservoir souring.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims to follow in any manner.

Synthesis of a scale squeeze lifetime extension additive or SLE of this disclosure was confirmed (see Example 1 hereinbelow) and its propensity for lifetime enhancement demonstrated through a laboratory core-flood study (see Example 2 hereinbelow). The benign nature of the SLE additive with respect to rock formation damage was confirmed during formation damage testing (see Example 3 hereinbelow).

### Example 1

### SLE Synthesis

An SLE of this disclosure was formed by stirring a known mass of chloride intercalated hydrotalcite solid in a solution containing an excess of DTPMP for 3-6 hours to ion exchange the chloride ions of the intercalation layer 30 with DTPMP. Filtering and washing of the filtered solid with deionized water were then performed.

The synthesis of the DTPMP-intercalated LDH SLE was confirmed using X-ray diffraction (XRD) and attenuated total reflection Fourier transform infrared spectroscopy (ATR-FTIR). XRD data were obtained by grinding a portion of the sample by hand using a pestle and mortar. The ground powder was then loaded into a small Bruker zero background powder sample holder. X-ray diffraction data were collected on a Bruker D8 A25 instrument with Lynxeye XE detector using CuKa radiation.

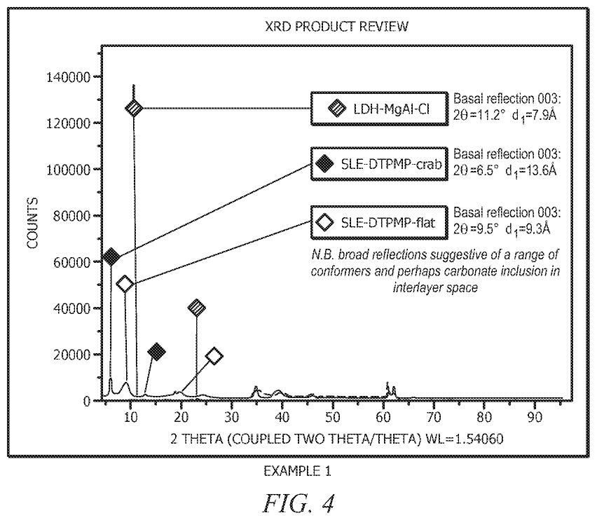

FIG. 4 shows the X-ray diffraction (XRD) results (two diffraction patterns) obtained for the baseline hydrotalcite LDH (labeled MgAl-Cl) and for the SLEs comprising LDH intercalated with diethylenetriamine penta(methylene phosphonic acid (DTPMP) in its ‘crab-shaped’ conformer (labeled SLE-DTPMP-crab) and DTPMP in its ‘flat’ conformer (labeled SLE-DTPMP-flat). FIG. 4 illustrates diffraction intensity as a function of 2 theta (2θ), wherein θ is Bragg angle. The parent MgAl-Cl hydrotalcite LDH exhibits a basal reflection 003 having a value of 2θ of 11.2° corresponding to an inter-layer spacing d₁ of 7.9 Å. The SLE of this disclosure comprising DTPMP-crab intercalated LDH exhibited a basal reflection 003 having a value of 2θ of 6.5° and an inter-layer spacing di of 13.6 Å. The SLE of this disclosure comprising DTPMP-flat intercalated LDH exhibited a basal reflection 003 having a value of 2θ of 9.5° and an inter-layer spacing d₁ of 9.3 Å. The broad reflections corresponding to the SLE are indicative of minor variations in the d-spacing of the LDH layers, which suggests both ‘crab-like’ and ‘flat’ conformers of the DTPMP intercalated between the layers may vary slightly in orientation throughout the structure, and perhaps carbonate inclusion in the interlayer space.

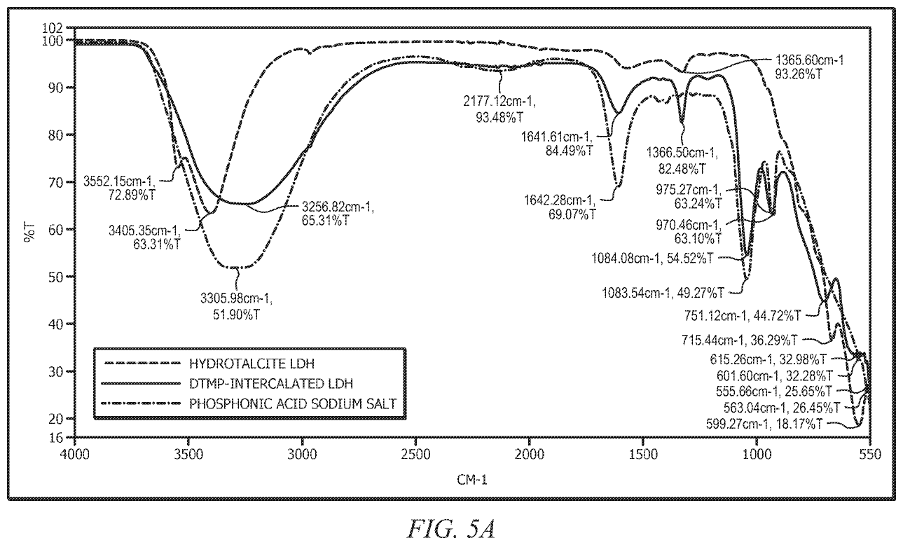

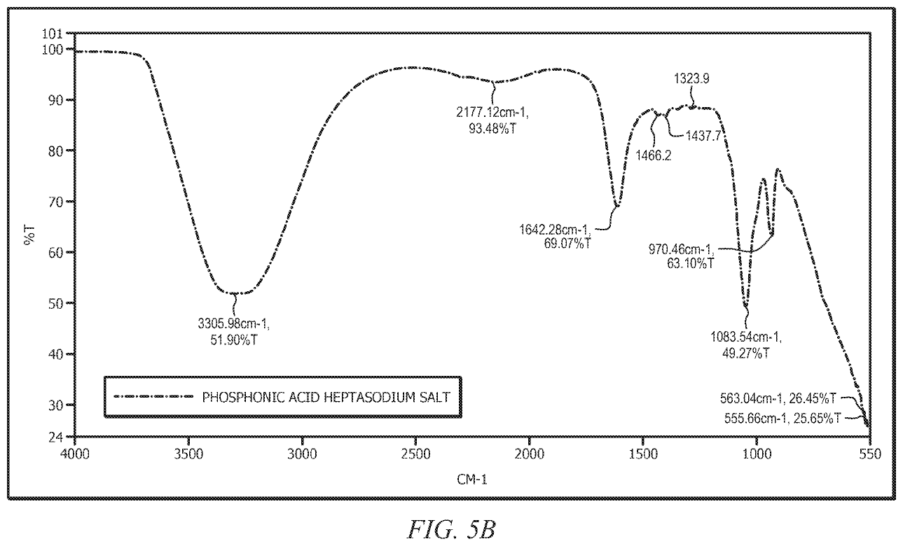

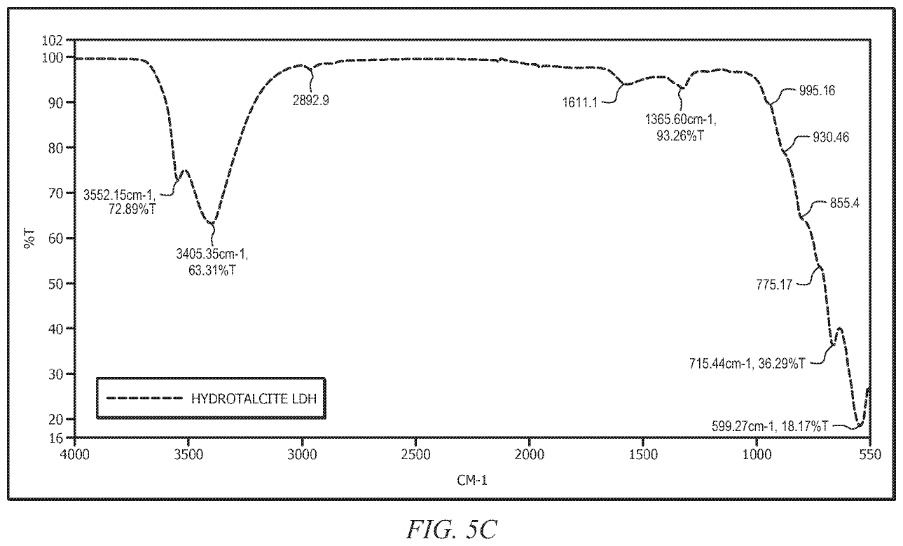

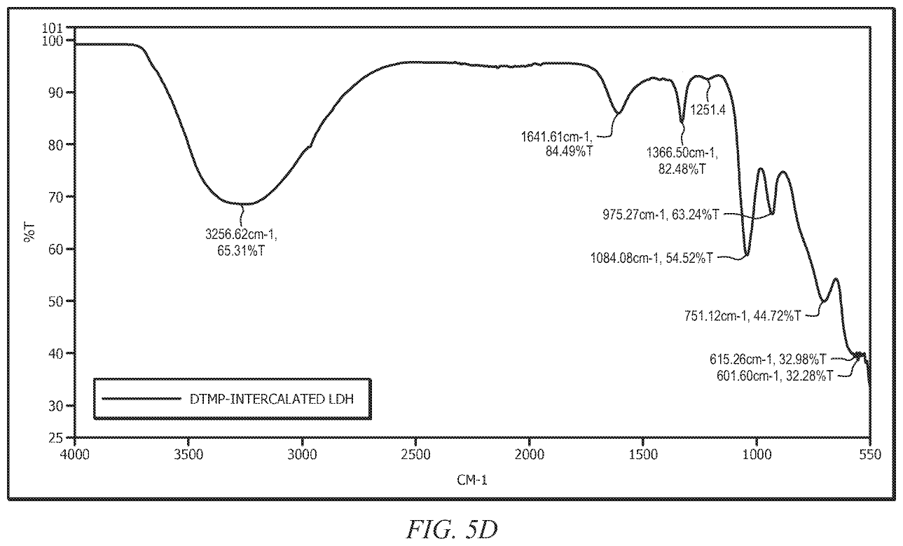

ATR-FTIR data were obtained using a PerkinElmer Spectrum 400 FTIR system with a single-bounce diamond universal ATR accessory. ATR-FTIR measurements were undertaken on the hydrotalcite starting material, DTPMP starting material, and DTPMP-intercalated LDH product by, for each sample, first obtaining a background of the clean diamond ATR crystal and then entirely covering the crystal with the sample powder and recording a spectrum. The resultant ATR-FTIR spectra are shown in FIGS. 5A-5D. FIG. 5A shows the overlaid spectra for the hydrotalcite LDH, the DTMP-intercalated LDH, and the phosphonic acid heptasodium salt, while FIG. 5B, FIG. 5C, and FIG. 5D depict the respective detailed spectra for the phosphonic acid heptasodium salt, the starting material hydrotalcite LDH, and the SLE product according to an embodiment of this disclosure comprising the DTMP-intercalated LDH. The spectrum for the SLE product DTMP-intercalated LDH comprises features of both the starting material IR data; it is noted that adsorptions observed in the spectra for the phosphonic acid heptasodium salt (e.g., in FIG. 5B) are also present in the spectrum for the DTMP-intercalated LDH (e.g., in FIG. 5D), which confirms successful incorporation of SI in the product.

### Example 2

### Coreflood Studies

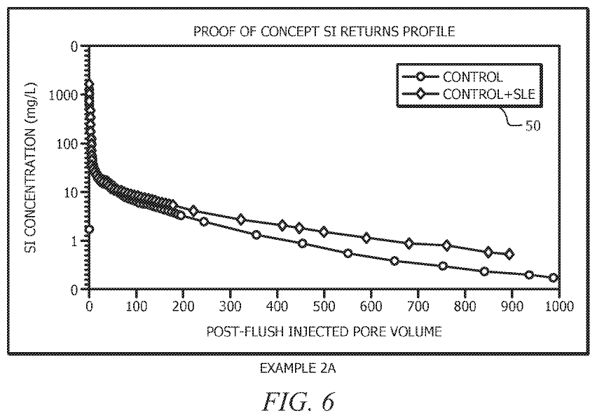

Example 2A: Two coreflood studies were undertaken to study the enhancement of squeeze lifetime by the herein-disclosed SLEs. The first coreflood was a ‘control’. A commercially available DETA phosphonate scale inhibitor (DTPMP) was injected as part of a standard squeeze treatment package into a core sample of Castlegate core material. The second coreflood was a squeeze lifetime enhancement (SLE) treatment comprising an SLE of this disclosure. In this experiment, the SLE comprised DTPMPintercalated hydrotalcite LDH. The second treatment was identical to the control, but with a mass of the herein-disclosed SLE injected alongside the same volume of the DETA phosphonate SI in the main treatment of the first coreflood. FIG. 6 is a plot of SI concentration (mg/L) as a function of number of post-flush injected pore volumes,

As seen in Table 1, a comparison of the control and control+SLE confirmed that the LDH additive (i.e., the SLE) extended the lifetime of the squeeze treatment. At a minimum effective dose (MED) of 10 ppm, the extension of the squeeze lifetime was 3.9%. At an MED of 5 ppm, the extension of the squeeze lifetime was 23.4%. At an MED of 1 ppm, the extension of the squeeze lifetime was 51.9%.

TABLE 1

| | | | Lifetime |
|---|---|---|---|
| Hypothetical | Lifetime (Pore Volumes to MED) | | Improvement |
| MED (ppm) | Control | Control + SLE | (%) |
| 10 | 64.75 | 67.25 | +3.9 |
| 5 | 147.5 | 182 | +23.4 |
| 1 | 431 | 654.5 | +51.9 |

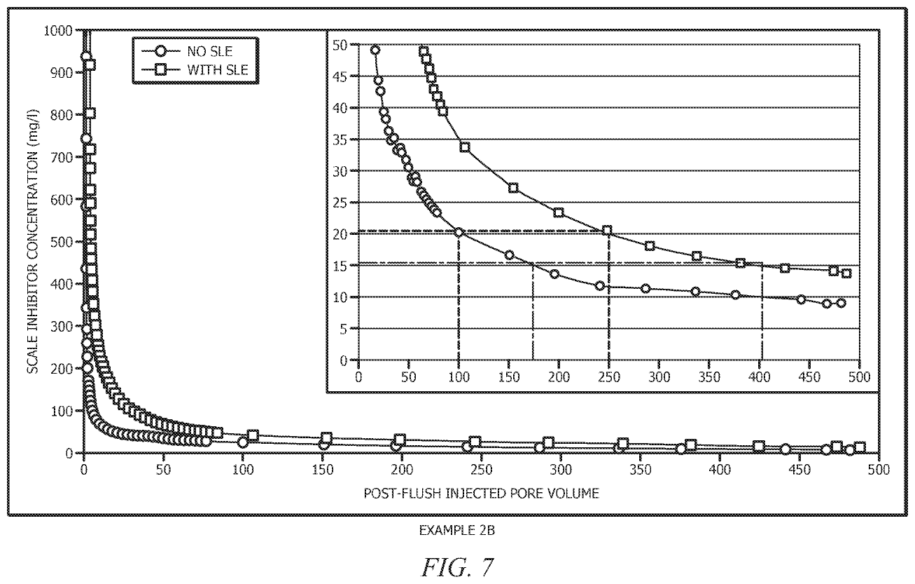

Example 2B: Further coreflood studies were undertaken to study the enhancement of squeeze lifetime by the herein-disclosed SLEs. In these further coreflood studies, a first coreflood was a ‘control’. A commercially available scale inhibitor (Nalco EC0660A, available from Nalco Champion) was injected as part of a standard squeeze treatment package into a core sample of core material. A second coreflood was a squeeze lifetime enhancement (SLE) treatment comprising an SLE of this disclosure. In this experiment, the SLE comprised SI-intercalated hydrotalcite LDH. The second treatment was identical to the control, but with a mass of the SLE injected alongside the same volume of the SI in the main treatment of the first coreflood. FIG. 7 is a plot of SI concentration (mg/L) as a function of number of post-flush injected pore volumes,

As seen in Table 2, a comparison of the control and control+SLE confirmed that the LDH additive (i.e., the SLE) extended the lifetime of the squeeze treatment. A minimum effective dose (MED) of 10 ppm was not reached after 488 pore volumes of post-flush (at which point the SI concentration was still 14 ppm). At an MED of 15 ppm, the extension of the squeeze lifetime was 131%. At an MED of 20 ppm, the extension of the squeeze lifetime was 138%.

TABLE 2

| | Lifetime (Pore Volumes to MED) | | Lifetime |
|---|---|---|---|
| Hypothetical | Control | | Improvement |
| MED (ppm) | (EC6660A) | Control + SLE | (%) |
| 20 | 105 | 250 | 138 |
| 15 | 175 | 405 | 131 |
| 10 | 400 | Not reached by 488 pore | N/A |
| | | volumes of post-flush | |

### Example 3:

### Formation Damage Study

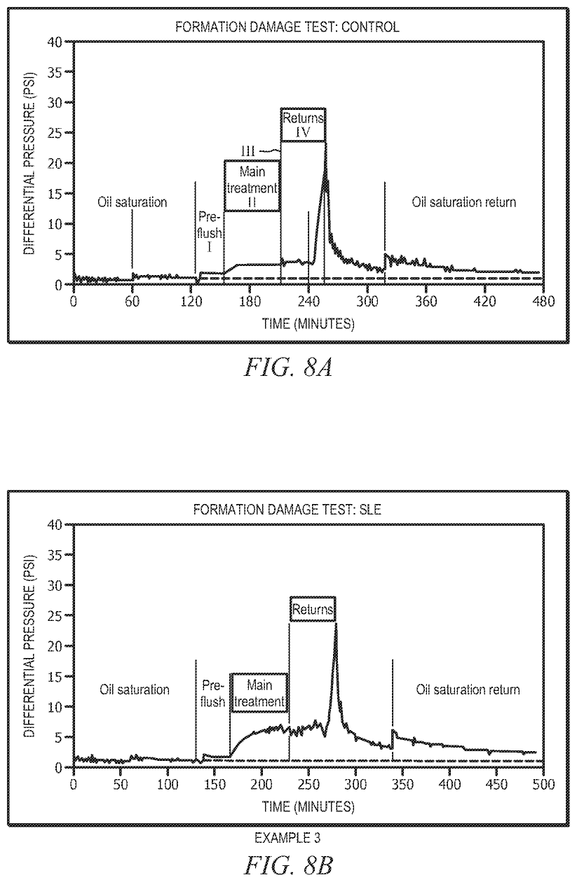

The formation damage potential of the SLE was assessed after shut-in of the chemical and chemical return stages of Example 2A. FIGS. 8A and 8B show the results of the formation damage tests. FIG. 8A shows the differential pressure (psi) as a function of time (minutes) for the formation damage test utilizing the control, and FIG. 8B shows the differential pressure (psi) as a function of time (minutes) for the formation damage test utilizing the herein-disclosed SLE. No formation damage or filter cake was observed due to injection of the SLE. The data suggest that, under the conditions tested, the SLE was injected successfully with no major impact on injectivity.

### ADDITIONAL DISCLOSURE

The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and such variations are considered within the scope and spirit of the present disclosure. Alternative embodiments that result from combining, integrating, and/or omitting features of the embodiment(s) are also within the scope of the disclosure. While compositions and methods are described in broader terms of “having”, “comprising,” “containing,” or “including” various components or steps, the compositions and methods can also “consist essentially of” or “consist of” the various components and steps. Use of the term “optionally” with respect to any element of a claim means that the element is required, or alternatively, the element is not required, both alternatives being within the scope of the claim.

Numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents, the definitions that are consistent with this specification should be adopted.

Embodiments disclosed herein include:

A: A material comprising: a layered double hydroxide (LDH) having a scale inhibitor (SI) intercalated between positively-charged layers thereof.

B: A scale treatment fluid comprising: a carrier fluid; and a layered double hydroxide (LDH) having a scale inhibitor (SI) intercalated between positively-charged layers thereof.

C: A scale treatment fluid comprising: a carrier fluid; a layered double hydroxide (LDH) comprising positively-charged layers; and a scale inhibitor (SI), wherein the scale inhibitor comprises one or more ions capable of being intercalated between the positively-charged layers of the LDH.

D: A method of treating a wellbore, the method comprising: injecting, as part of a scale squeeze treatment of a reservoir, a treatment fluid into the wellbore, wherein the treatment fluid comprises a layered double hydroxide (LDH) comprising positively-charged layers with intercalated anionic layers therebetween; and releasing a scale inhibitor (SI) within the reservoir based on the injection of the treatment fluid comprising the LDH.

E: A method of making a wellbore treatment fluid, the method comprising: mixing a layered double hydroxide (LDH) with a solution comprising at least one scale inhibitor (SI), wherein the layered double hydroxide (LDH) solid comprises positively-charged layers with anionic layers comprising one or more anions intercalated between the positively-charged layers; and ion exchanging of the one or more anions with the scale inhibitor to create a material comprising the SI encapsulated in the anionic layers intercalated between the positively-charged layers of the LDH.

F: A method of treating a wellbore, the method comprising: injecting a scale inhibitor (SI) into a reservoir containing a layered double hydroxide (LDH), wherein the LDH comprises positively-charged layers with intercalated anionic layers therebetween; intercalating the SI into the anionic layers of the LDH within the reservoir; and releasing the SI to provide scale inhibition during production of fluid from the reservoir.

Each of embodiments A, B, C, D, E, and F may have one or more of the following additional elements: Element 1: wherein the SI is selected from water-soluble organic molecules comprising at least 2 phosphonic and/or sulphonic acid groups, or at least 2 carboxylic, acid groups; oligomers, polymers, and monomers comprising at least one hydroxyl group and/or amino nitrogen atom; polycarboxylic acids; polymeric anionic compounds; salts thereof; or combinations thereof. Element 2: wherein the SI comprises diethyleneamine penta(methylene) phosphonic acid (DTPMP); ethylenediamine tetra(methylene phosphonate); diethylenetriamine penta(methylene phosphonate); triamine- and tetramine-polymethylene phosphonates with 2-4 methylene groups between each N atom and at least 2 of the numbers of methylene groups in each phosphonate being different; lactic acid; tartaric acids; polyvinyl sulphonic acid; and poly(meth)acrylic acids, optionally comprising at least some phosphonyl or phosphinyl groups; or a combination thereof. Element 3: wherein the LDH comprises hydrotalcite. Element 4: wherein the LDH comprises particles having at least one dimension, as measured by scanning electron microscopy or dynamic light scattering that is less than 1 micron. Element 5: wherein the LDH comprises particles having at least one dimension, as measured by scanning electron microscopy or dynamic light scattering, that is less than 100 nm. Element 6: wherein the LDH comprises particles having a surface area, as measured by nitrogen adsorption (Brunauer-Emmett-Teller (BET) method), that is greater than about 40 m²/g. Element 7: wherein the particles have a morphology selected from platelets, spheres, cuboids, flowers, rods, or a combination thereof. Element 8: wherein the composition, order, structure, and/or stacking of the positively-charged layers of the LDH provides desired intercalation properties. Element 9: wherein a weight percent (wt %) loading of anions from the SI per mass of the LDH is greater than or equal to about 50% of a maximum wt % loading of the anions. Element 10: further comprising at least one other scale inhibitor (SI) intercalated between positively-charged layers of the LDH. Element 11: comprising less than or equal to about 20, 15, 10, 9, 8, 7, 6, 5, 4, 3, 2, or 1 weight percent (wt %) of the LDH. Element 12: wherein the LDH is injected into the wellbore as a component of a pre-flush fluid, a main scale treatment fluid comprising a scale inhibitor (SI), an over-flush fluid employed to push the main treatment fluid to a desired depth of the reservoir, or a combination thereof. Element 13: wherein the layered double hydroxide (LDH) contains the SI intercalated between the positively-charged layers. Element 14: further comprising intercalating the SI into the LDH prior to injecting the treatment fluid into the wellbore. Element 15: wherein the LDH further comprises at least one additional scale inhibitor (SI) intercalated between the positively-charged layers. Element 16: further comprising selecting an LDH having a composition, order, structure, and/or stacking of the positively-charged layers thereof that provides desired intercalation properties between the LDH and the scale inhibitor (SI). Element 17: wherein the LDH comprises particles having at least one dimension, as measured by scanning electron microscopy or dynamic light scattering that is less than 1 micron, less than 100 nm, or both. Element 18: wherein the LDH comprises particles having a size that is less than about 1/7 of a mean pore throat diameter of a rock formation in a portion of the reservoir being subjected to the scale squeeze treatment. Element 19: wherein the LDH is injected into the wellbore as a component of a treatment fluid comprising less than or equal to about 20, 15, 10, 9, 8, 7, 6, 5, 4, 3, 2, or 1 weight percent (wt %) of the LDH. Element 20: wherein the treatment fluid further comprises from about 10 to about 25, from about 10 to about 20, from about 10 to about 30, or less than or equal to about 30, 20, or 10 wt % of the SI, and at least a portion of the SI is intercalated into the LDH during injecting of the treatment fluid into the wellbore. Element 21: further comprising injecting the SI into the wellbore subsequent injecting the treatment fluid therein, whereby at least a portion of the SI is intercalated into the LDH downhole. Element 22: wherein utilization of the LDH encapsulates the SI and increases the squeeze lifetime relative to a same wellbore treatment absent the LDH, wherein the squeeze lifetime is the time for the concentration of the SI produced back to the wellbore to fall below a minimum effective dose (MED), by: (a) increasing a mass of the SI retained in the reservoir following the scale squeeze treatment; (b) slowing the release of the SI from the reservoir; or both (a) and (b). Element 23: wherein the mass of the SI retained in the reservoir, the squeeze lifetime or both are increased by at least 1, 2, 3, 4, 5, 6, 7, 8, 9, or 10%. Element 24: further comprising: recharging the LDH introduced into the reservoir as part of the scale squeeze treatment with SI by introducing additional SI into the reservoir after the scale squeeze treatment in which the LDH was introduced into the reservoir, whereby at least a portion of the additional SI is encapsulated by the LDH. Element 25: further comprising: mixing for a time period of at least one hour; filtering to separate solid from liquid subsequent to the mixing; washing the separated solid after filtering; or a combination thereof.

While certain embodiments have been shown and described, modifications thereof can be made by one skilled in the art without departing from the teachings of this disclosure.

Numerous other modifications, equivalents, and alternatives, will become apparent to those skilled in the art once the above disclosure is fully appreciated. It is intended that the following claims be interpreted to embrace such modifications, equivalents, and alternatives where applicable. Accordingly, the scope of protection is not limited by the description set out above but is only limited by the claims which follow, that scope including equivalents of the subject matter of the claims.

The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and such variations are considered within the scope and spirit of the present disclosure. Alternative embodiments that result from combining, integrating, and/or omitting features of the embodiment(s) are also within the scope of the disclosure. While compositions and methods are described in broader terms of “having”, “comprising,” “containing,” or “including” various components or steps, the compositions and methods can also “consist essentially of” or “consist of” the various components and steps. Use of the term “optionally” with respect to any element of a claim means that the element is required, or alternatively, the element is not required, both alternatives being within the scope of the claim.

What is claimed is:

1. A scale inhibition fluid for use in a wellbore, the scale inhibition fluid comprising:
a layered double hydroxide (LDH) having a scale inhibitor (SI) intercalated between positively-charged layers thereof.

2. The scale inhibition fluid of claim 1, wherein the SI is selected from water-soluble organic molecules comprising at least 2 phosphonic and/or sulphonic acid groups.

3. The scale inhibition fluid of claim 1, wherein the SI comprises a material selected from water-soluble organic molecules comprising at least 2 carboxylic acid groups; oligomers, polymers, and monomers comprising at least one hydroxyl group and/or amino nitrogen atom; polycarboxylic acids; polymeric anionic compounds; salts thereof or combinations thereof.

4. The scale inhibition fluid of claim 1, wherein the SI comprises diethyleneamine penta(methylene) phosphonic acid (DTPMP); ethylenediamine tetra(methylene phosphonate); diethylenetriamine penta(methylene phosphonate); triamine- and tetramine-polymethylene phosphonates with 2-4 methylene groups between each N atom and at least 2 of the numbers of methylene groups in each phosphonate being different; lactic acid; tartaric acids; polyvinyl sulphonic acid; and poly(meth)acrylic acids, optionally comprising at least some phosphonyl or phosphinyl groups; or a combination thereof.

5. The scale inhibition fluid of claim 1, wherein the LDH comprises hydrotalcite.

6. The scale inhibition fluid of claim 1, wherein the LDH comprises particles having at least one dimension, as measured by scanning electron microscopy or dynamic light scattering that is less than 1 micron.

7. The scale inhibition fluid of claim 1, wherein the LDH comprises particles having at least one dimension, as measured by scanning electron microscopy or dynamic light scattering, that is less than 100 nm.

8. The scale inhibition fluid of claim 1, wherein the LDH comprises particles having a surface area, as measured by nitrogen adsorption (Brunauer-Emmett-Teller (BET) method), that is greater than about 40 m²/g.

9. The scale inhibition fluid of claim 8, wherein the particles have a morphology selected from platelets, spheres, cuboids, flowers, rods, or a combination thereof.

10. The scale inhibition fluid of claim 1, wherein the composition, order, structure, and/or stacking of the positively-charged layers of the LDH provides desired intercalation properties.

11. The scale inhibition fluid of claim 1, wherein a weight percent (wt %) loading of anions from the SI per mass of the LDH is greater than or equal to about 50% of a maximum wt % loading of the anions.

12. The scale inhibition fluid of claim 1, further comprising at least one other scale inhibitor (SI) intercalated between positively-charged layers of the LDH.

13. The scale inhibition fluid of claim 1, further comprising:
a carrier fluid.

14. The scale inhibition fluid of claim 13, comprising less than or equal to about 20 weight percent (wt %) of the LDH.

15. A method of treating a wellbore, the method comprising:
injecting, as part of a scale squeeze treatment of a reservoir, a treatment fluid into the wellbore, wherein the treatment fluid comprises a layered double hydroxide (LDH) comprising positively-charged layers with intercalated anionic layers therebetween, wherein the anionic layers comprise a scale inhibitor (SI); and
releasing the SI from the LDH within the reservoir based on the injection of the treatment fluid comprising the LDH.

16. The method of claim 15, wherein the SI is selected from water-soluble organic molecules comprising at least 2 phosphonic and/or sulphonic acid groups.

17. The method of claim 15, wherein the LDH is injected into the wellbore as a component of a pre-flush fluid, a main scale treatment fluid comprising the scale inhibitor (SI), an over-flush fluid employed to push the main treatment fluid to a desired depth of the reservoir, or a combination thereof.

18. The method of claim 15, wherein the layered double hydroxide (LDH) contains the SI intercalated between the positively-charged layers.

19. The method of claim 18, further comprising: intercalating the SI into the LDH prior to injecting the treatment fluid into the wellbore.

20. The method of claim 18, wherein the LDH further comprises at least one additional scale inhibitor (SI) intercalated between the positively-charged layers.

21. The method of claim 18, wherein the SI comprises a material selected from water-soluble organic molecules comprising at least 2 carboxylic acid groups; oligomers, polymers, and monomers comprising at least one hydroxyl group and/or amino nitrogen atom; polycarboxylic acids; polymeric anionic compounds; salts thereof; or combinations thereof.

22. The method of claim 21, wherein the SI comprises diethyleneamine penta(methylene) phosphonic acid (DTPMP); ethylenediamine tetra(methylene phosphonate); diethylenetriamine penta(methylene phosphonate); triamine- and tetramine-polymethylene phosphonates with 2-4 methylene groups between each N atom and at least 2 of the numbers of methylene groups in each phosphonate being different; lactic acid; tartaric acids; polyvinyl sulphonic acid; and poly(meth)acrylic acids, optionally comprising at least some phosphonyl or phosphinyl groups; or a combination thereof.

23. The method of claim 15, wherein a weight percent (wt %) loading of anions from the SI per mass of the LDH is greater than or equal to about 50% of a maximum wt % loading of the anions.

24. The method of claim 15, wherein the LDH comprises particles having a surface area, as measured by nitrogen adsorption (Brunauer-Emmett-Teller (BET) method), that is greater than about 40 m²/g.

25. The method of claim 24, wherein the particles have a morphology selected from platelets, spheres, cuboids, flowers, rods, or a combination thereof.

26. The method of claim 15, further comprising selecting an LDH having a composition, order, structure, and/or stacking of the positively-charged layers thereof that provides desired intercalation properties between the LDH and the scale inhibitor (SI).

27. The method of claim 15, wherein the LDH comprises hydrotalcite.

28. The method of claim 15, wherein the LDH comprises particles having at least one dimension, as measured by scanning electron microscopy or dynamic light scattering that is less than 1 micron, less than 100 nm, or both.

29. The method of claim 15, wherein the LDH comprises particles having a size that is less than about 1/7 of a mean pore throat diameter of a rock formation in a portion of the reservoir being subjected to the scale squeeze treatment.

30. The method of claim 15, wherein the LDH is injected into the wellbore as a component of a treatment fluid comprising less than or equal to about 20 weight percent (wt %) of the LDH.

31. The method of claim 15, wherein the treatment fluid further comprises less than or equal to about 30 weight percent (wt %) of the SI, and at least a portion of the SI is intercalated into the LDH during injecting of the treatment fluid into the wellbore.

32. The method of claim 15, further comprising injecting the SI into the wellbore subsequent injecting the treatment fluid therein, whereby at least a portion of the SI is intercalated into the LDH downhole.

33. The method of claim 15, wherein utilization of the LDH encapsulates the SI and increases the squeeze lifetime relative to a same wellbore treatment absent the LDH, wherein the squeeze lifetime is the time for the concentration of the SI produced back to the wellbore to fall below a minimum effective dose (MED), by:
(a) increasing a mass of the SI retained in the reservoir following the scale squeeze treatment;
(b) slowing the release of the SI from the reservoir; or both (a) and (b).

34. The method of claim 33, wherein the mass of the SI retained in the reservoir, the squeeze lifetime or both are increased by at least 1%.

35. The method of claim 15, further comprising: recharging the LDH introduced into the reservoir as part of the scale squeeze treatment with SI by introducing additional SI into the reservoir after the scale squeeze treatment in which the LDH was introduced into the reservoir, whereby at least a portion of the additional SI is encapsulated by the LDH.

36. A method of making a wellbore treatment fluid, the method comprising:
mixing a layered double hydroxide (LDH) with a solution comprising at least one scale inhibitor (SI), wherein the layered double hydroxide (LDH) solid comprises positively-charged layers with anionic layers comprising one or more anions intercalated between the positively-charged layers; and
ion exchanging of the one or more anions with the SI to create a material comprising the SI encapsulated in the anionic layers intercalated between the positively-charged layers of the LDH.

37. The method of claim 36, wherein the SI is selected from water-soluble organic molecules comprising at least 2 phosphonic and/or sulphonic acid groups.

38. The method of claim 36, further comprising:
mixing for a time period of at least one hour;
filtering to separate solid from liquid subsequent to the mixing;
washing the separated solid after filtering;
or a combination thereof.

39. The method of claim 36, wherein the SI comprises a material selected from water-soluble organic molecules comprising at least 2 carboxylic acid groups; oligomers, polymers, and monomers comprising at least one hydroxyl group and/or amino nitrogen atom; polycarboxylic acids; polymeric anionic compounds; salts thereof; or combinations thereof.

40. The method of claim 36, wherein the SI comprises diethyleneamine penta(methylene) phosphonic acid (DTPMP); ethylenediamine tetra(methylene phosphonate); diethylenetriamine penta(methylene phosphonate); triamine- and tetramine-polymethylene phosphonates with 2-4 methylene groups between each N atom and at least 2 of the numbers of methylene groups in each phosphonate being different; lactic acid; tartaric acids; polyvinyl sulphonic acid; and
poly(meth)acrylic acids, optionally comprising at least some phosphonyl or phosphinyl groups; or a combination thereof.

41. The method of claim 36, wherein the LDH comprises hydrotalcite.
